(19) United States
(12) Patent Application Publication
(10) Pub. No.: US 2006/0065146 A1
(43) Pub. Date: Mar. 30, 2006

(54) Printing plate material

(76) Inventor: Takahiro Mori, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/224,865

(22) Filed: Sep. 12, 2005

(30) Foreign Application Priority Data
Sep. 27, 2004 (JP) JP2004-279039

(51) Int. Cl. B41N 1/00

(52) U.S. Cl. 101/454

(57) ABSTRACT

Disclosed is a printing plate material comprising a substrate and provided thereon, a hydrophilic layer and an image formation layer, wherein the hydrophilic layer contains particles (A) having a particle size of from 1 to 10 μm and having a new Mohs hardness of from 11 to 15, and particles (B) having a particle size of from 10 nm to less than 1 μm, the particles (B) having a true specific gravity greater than the particles (A).

This application is based on Japanese Patent Application No. 2004-279039 filed on Sep. 27, 2004 in Japanese Patent Office, the entire content of which is hereby incorporated by reference.

### FIELD OF THE INVENTION

The present invention relates to a printing plate material, and particularly to a printing plate material capable of forming an image according to a computer to plate (CTP) system.

### BACKGROUND OF THE INVENTION

Presently, in a plate making system for a planographic printing plate, a CTP (computer to plate) system has been developed which writes a digital image directly on a printing plate material employing a laser.

In recent years, a printing plate material, which does not require any development employing a developer containing specific chemicals (such as alkalis, acids, and solvents), and can be applied to a conventional printing press, has been sought as a printing plate material for the CTP system. Known are a chemical-free type printing plate material such as a phase change type printing plate material requiring no development process, a printing plate material which can be processed with water or a neutral processing liquid comprised mainly of water, or a printing plate material capable of being developed on a printing press at initial printing stage and requiring no development process; and a printing plate material called a processless printing plate material.

As the processless printing plate material, a on-press development type printing plate material is known which removes an image formation layer at non-image portions on a printing press, employing dampening water or printing ink. There is, for example, a printing plate material comprising a hydrophilic layer or a grained aluminum plate and provided thereon, an image formation layer containing thermoplastic particles, a water soluble binder, and a light-to-heat conversion material disclosed in Japanese Patent Publication Nos. 2938397 and 2938398.

The above printing plate material comprising an image formation layer containing a light-to-heat conversion material can be used as a printing plate material for a processless CTP. However, this printing plate material has problems in that sensitivity or printing durability is poor, color contamination due to the light-to-heat conversion material is likely to occur during printing, or stain elimination property is insufficient.

In order to solve the above problems, a printing plate material has been proposed which comprises a hydrophilic layer with a specific surface shape containing porous inorganic particles and a thermosensitive image formation layer containing thermoplastic particles, whereby printing durability and scratch resistance (property preventing stain occurrence due to scratches) are improved (See Japanese Patent O.P.I. Publication No. 2003-231374.).

However, even this printing plate material is not sufficient in view of scratch resistance.

In the above printing plate material, the hydrophilic layer is known which contains, in addition to the porous inorganic particles, non-porous metal oxide particles (such as those of silica, alumina, titania, zirconia, iron oxides, or chromium oxide) or non-porous inorganic particles such as metal carbide particles (for example, those of silicon carbide), boron nitride particles or diamond particles (see Japanese Patent O.P.I. Publication No. 2000-158839).

However, this printing plate material has still problems in that production stability is poor which is presumed as result from poor dispersibility of particles in the hydrophilic layer coating solution or printability (such as initial printability) is insufficient.

### SUMMARY OF THE INVENTION

An object of the invention is to provide a printing plate material having an excellent production stability, excellent printability and high scratch resistance.

### BRIEF DESCRIPTION OF THE DRAWING

FIG. 1 shows a main structure of a coating line employing a slide bead coater.

### DETAILED DESCRIPTION OF THE INVENTION

The above object of the invention is attained by one of the following constitutions.

1. A printing plate material comprising a substrate and provided thereon, a hydrophilic layer and an image formation layer, wherein the hydrophilic layer contains particles (A) having a particle size of from 1 to 10 μm and having a new Mohs hardness of from 11 to 15, and particles (B) having a particle size of from 10 nm to less than 1 μm, the particles (B) having a true specific gravity greater than the particles (A).

2. The printing plate material of item 1 above, wherein the particles (A) are metal oxide particles.

3. The printing plate material of item 1 above, wherein the particles (B) have a light-to-heat conversion function.

4. The printing plate material of item 1 above, wherein the content of the particles (B) is higher than that of the particles (A) in the hydrophilic layer.

5. The printing plate material of item 1 above, wherein the image formation layer contains thermoplastic hydrophobic particles.

6. The printing plate material of item 1 above, wherein the image formation layer contains microcapsules encapsulating a hydrophobic material.

7. The printing plate material of item 1 above, wherein the image formation layer contains a blocked isocyanate compound.

8. The printing plate material of item 1 above, wherein the total content of the particles (A) and (B) in the hydrophilic layer is from 15 to 70% by weight.

9. The printing plate material of item 1 above, wherein the total content of the particles (A) and (B) in the hydrophilic layer is from 30 to 70% by weight.

10. The printing plate material of item 1 above, wherein the hydrophilic layer and the image formation layer are provided on the substrate in that order.

The present invention is characterized in that in a printing plate material comprising a substrate and provided thereon, a hydrophilic layer and an image formation layer, the hydrophilic layer contains particles (A) having a particle size of from 1 to 10 μm and having a new Mohs hardness of from 11 to 15, and particles (B) having a particle size of from 10 nm to less than 1 μm, wherein the particles (B) have a true specific gravity greater than the particles (A).

In the invention, the printing plate material is preferably a printing plate material prepared by a process comprising the steps of coating on a substrate a coating liquid for a hydrophilic layer containing the particles (A) and the particles (B) to form a coating hydrophilic layer and trying the coating hydrophilic layer to form a hydrophilic layer.

(Particles (A) Having a Particle Size of from 1 to 10 μm and Having a New Mohs Hardness of from 11 to 15)

Particles having a new Mohs hardness of from 11 to 15 are particles generally used as agents. Examples thereof include the following particles: particles of α-alumina (Al₂O₃) having a new Mohs hardness of 12 and a true specific gravity of 4.4 g/cm³, silicon carbide (SiC) having a new Mohs hardness of 13 and a true specific gravity of 3.18 g/cm³, boron carbide (B₄C) having a new Mohs hardness of 14 and a true specific gravity of 2.51 g/cm³, cubic boron nitride (cBN) having a new Mohs hardness of 14 and a true specific gravity of 3.48 g/cm³, and diamond having a new Mohs hardness of 15 and a true specific gravity of 3.52 g/cm³.

Particles contained in the hydrophilic layer of the printing plate material are preferably particles having a high hydrophilic surface. Of particles described above, particles with high hydrophilicity are preferred, metal oxide particles are more preferred, and α-alumina particles are especially preferred.

As the α-alumina particles, particles manufactured according to a crushing method can be used. As the α-alumina particles are preferred α-alumina particles having a uniform particle size distribution, for example, α-alumina particles manufactured by hydrolysis of aluminum alkoxide or by thermal decomposition or CVD (Chemical Vapor Deposition) of alum.

Of these, α-alumina particles manufactured by CVD are especially preferred, and examples thereof include SUMICORUNDUM series produced by Sumitomo Kagaku Co., Ltd. (Particles (B) having a particle size of from 10 nm to less than 1 μm and a true specific gravity greater than the particles (A))

Particles (B) have a true specific gravity greater than the particles (A) and a particle size of from 10 nm to less than 1 μm.

When the hydrophilic layer in the invention contains particles B and plural kinds of particles (A), the particles (B) have a particle size of from 10 nm to less than 1 μm and a true specific gravity greater than that of particles (A) having the largest content by weight of the particles (A).

As the particles (B), there are particles of metals or metal oxides.

Of these, metal oxide particles with a highly hydrophilic surface are preferred, and pigment particles with a highly hydrophilic surface having a light to heat conversion function are more preferred. As the pigment particles with a highly hydrophilic surface having a light to heat conversion function in the invention, there are the following black metal oxide particles having a true specific gravity of not less than 4.5.

As one kind of the black metal oxide particles, there are black complex metal oxide particles. The black complex metal oxide particles are, for example, black complex metal oxide particles comprising at least two kinds of metals selected from Al, Ti, Cr, Mn, Fe, Ni, Co, Ni, Cu, Zn, Sb, and Ba. These particles can be manufacture according to methods disclosed in Japanese Patent O.P.I. Publication Nos. 8-27393, 9-25126, 9-237570, 9-241529, and 10-231441.

As the black complex metal oxides used in the invention, Cu—Cr—Mn type complex metal oxides (having a true specific gravity of about 5.8 g/cm³) are preferred, since they have high light-to-heat conversion function and high hydrophilicity.

As one kind of the black metal oxide particles, there are black iron oxide (Fe₃O₄) particles (having a true specific gravity of about 5.8 g/cm³). The black iron oxide particles also have high light-to-heat conversion function and high hydrophilicity.

The black iron oxide (Fe₃O₄) particles have an acicular ratio (major axis length/minor axis length) of preferably from 1 to 1.5. It is preferred that the black iron oxide particles are substantially spherical ones (having an acicular ratio of 1) or octahedral ones (having an acicular ratio of 1.4).

Examples of the black iron oxide particles include for example, TAROX series produced by Titan Kogyo K.K. Examples of the spherical particles include BL-100 (having a particle size of from 0.2 to 0.6 μm), and BL-500 (having a particle size of from 0.3 to 1.0 μm). Examples of the octahedral particles include ABL-203 (having a particle size of from 0.4 to 0.5 μm), ABL-204 (having a particle size of from 0.3 to 0.4 μm), ABL-205 (having a particle size of from 0.2 to 0.3 μm), and ABL-207 (having a particle size of 0.2 μm).

The black iron oxide particles may be surface-coated with inorganic compounds such as SiO₂. Examples of such black iron oxide particles include spherical particles BL-200 (having a particle size of from 0.2 to 0.3 μm) and octahedral particles ABL-207A (having a particle size of 0.2 μm), each having been surface-coated with SiO₂.

The particles (B) are smaller in particle size than, and higher in specific gravity than the particles (A). Stable dispersion of the particles (B) in a hydrophilic coating solution minimizes sedimentation of particles (A). This is considered to be the reason that good coating stability can be obtained.

Particularly, black iron oxide particles, having a slight magnetic property, form a steric structure in which the particles weakly bind with each other through the different polarity in the coating solution, and form a property difficult to sediment (difficult to form a hard cake). This is considered to be the reason that they exhibit a high sedimentation preventing property.

In the invention, the average particle size of particles (B) in the hydrophilic layer coating solution is preferably from 10 nm to less than 1 μm, and more preferably from 50 nm to less than 1 μm, in view of dispersion stability of the coating solution and color density of hydrophilic layer.

In the invention, the average particle size of particles (A) in the hydrophilic layer coating solution is preferably from 1 to 10 μm, and more preferably from 2 to 5 μm, in view of dispersion stability of the coating solution and layer strength of hydrophilic layer.

In the invention, particle size is defined as a diameter of a circle circumscribing a projected image of particles on an electron micrograph of the particle. The average particle size is a number average of the particle size obtained above, the subject particles being 50 particles selected randomly.

The content of the particles (B) in the hydrophilic layer is preferably from 3 to 80% by weight, and more preferably from 5 to 60% by weight, in view of layer strength or color density of hydrophilic layer.

The content of the particles (B) in the hydrophilic layer is preferably from 100 to 300%, and more preferably from 150 to 200% of the content of the particles (A) in the hydrophilic layer. The total content of the particles (A) and (B) in the hydrophilic layer is preferably from 5 to 80% by weight, more preferably from 15 to 70% by weight, and most preferably from 30 to 70% by weight.

(Hydrophilic Layer)

The hydrophilic layer in the invention preferably contains a hydrophilic material.

As the hydrophilic material, metal oxides other than the particles (A) and (B) and hydrophilic resin can be used. The metal oxide is preferably used in the form of particles.

Materials used in the hydrophilic layer are preferably metal oxides, and more preferably metal oxide particles. Examples of the metal oxide particles include colloidal silica particles, an alumina sol, a titania sol and another metal oxide sol. The metal oxide particles may have any shape such as spherical, needle-like, and feather-like shape. The average particle size is preferably from 3 to 100 nm, and plural kinds of metal oxide each having a different size may be used in combination. The surface of the particles may be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder.

Among the above-mentioned, colloidal silica is particularly preferred. The colloidal silica has a high layer forming ability under a drying condition with a relative low temperature, and can provide a good layer strength. It is preferred that the colloidal silica is necklace-shaped colloidal silica or colloidal silica particles having an average particle size of not more than 20 nm. Further, it is preferred that the colloidal silica provides an alkaline colloidal silica solution as a colloid solution.

The necklace-shaped colloidal silica is a generic term of an aqueous dispersion system of spherical silica having a primary particle size of the order of nm. The necklace-shaped colloidal silica to be used in the invention means a “pearl necklace-shaped” colloidal silica formed by connecting spherical colloidal silica particles each having a primary particle size of from 10 to 50 μm so as to attain a length of from 50 to 400 nm.

The term of “pearl necklace-shaped” means that the image of connected colloidal silica particles is like to the shape of a pearl necklace.

The bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd.

As the products, there are Snowtex-PS-S (the average particle size in the connected state is approximately 110 nm), Snowtex-PS-M (the average particle size in the connected state is approximately 120 nm) and Snowtex-PS-L (the average particle size in the connected state is approximately 170 nm). Acidic colloidal silicas corresponding to each of the above-mentioned are Snowtex-PS-S—O, Snowtex-PS-M-O and Snowtex-PS-L-O, respectively. The necklace-shaped colloidal silica is preferably used in a hydrophilic layer as a porosity providing material for hydrophilic matrix phase, and porosity and strength of the layer can be secured by its addition to the layer. Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle size. The average particle size of the colloidal silica particles to be used in the invention is preferably not more than 20 nm, and more preferably 3 to 15 nm. As above-mentioned, the alkaline colloidal silica particles show the effect of inhibiting occurrence of the background contamination. Accordingly, the use of the alkaline colloidal silica particles is particularly preferable.

Examples of the alkaline colloidal silica particles having the average particle size within the foregoing range include Snowtex-20 (average particle size: 10 to 20 nm), Snowtex-30 (average particle size: 10 to 20 nm), Snowtex-40 (average particle size: 10 to 20 nm), Snowtex-N (average particle size: 10 to 20 nm), Snowtex-S (average particle size: 8 to 11 nm) and Snowtex-XS (average particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since appropriate porosity of the layer is maintained and the layer strength is further increased. The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

The hydrophilic layer in the invention preferably contains porous metal oxide particles as metal oxides. materials. Examples of the porous metal oxide particles include porous silica particles, porous aluminosilicate particles or zeolite particles, each described later.

The porous silica particles or porous aluminosilicate particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions.

The porous silica particles prepared from the gel by the wet method is particularly preferred.

The porous aluminosilicate particles can be prepared by the method described in, for example, JP O.P.I. No. 10-71764. Thus prepared aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume before the dispersion. The pore volume is closely related to water retention of the coated layer. As the pore volume increases, the water retention is increased, stain is difficult to occur, and water tolerance is high. Particles having a pore volume of more than 2.5 ml/g are brittle, resulting in lowering of durability of the layer containing them. Particles having a pore volume of less than 1.0 ml/g lower an anti-stain property and water tolerance.

The particle size of the particles dispersed in the hydrophilic layer (or in the dispersed state before formed as a layer) is preferably not more than 1 μm, and more preferably not more than 0.5 μm. Presence in the hydrophilic layer of particles with an extremely large size forms porous and sharp protrusions on the hydrophilic layer surface, and ink is likely to remain around the protrusions, which may produce stain at non-image portions of the printing plate and on the blanket of a press during printing.

Zeolite is a crystalline aluminosilicate, which is a porous material having voids of a regular three dimensional net work structure and having a pore size of 0.3 to 1 nm.

The particle size of the porous metal oxide particles dispersed in the hydrophilic layer is preferably not more than 1 μm, and more preferably not more than 0.5 μm.

The hydrophilic layer can contain layer structural clay mineral particles. Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte.

Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

An intercalation compound of the foregoing layer structural mineral particles such as a pillared crystal, or one treated by an ion exchange treatment or a surface treatment such as a silane coupling treatment or a complication treatment with an organic binder is also usable.

The structural mineral particles have an average particle size (an average of the largest particle length) of not more than 20 μm and an average aspect ratio of not less than 20, in a state contained in the layer (including the case that the particles have been subjected to swell processing and dispersing layer-separation processing), in view of scratch resistance. The structural mineral particles have an average particle size of preferably not more than 5 μm and an average aspect ratio of preferably not less than 50, and have an average particle size of more preferably not more than 1 μm and an average aspect ratio of more preferably not less than 50. When the average particle size falls within the range described above, continuity to the parallel direction, which is a trait of the layer structural particle, and softness, are given to the coated layer so that a strong dry layer in which a crack is difficult to be formed can be obtained.

The coating solution containing particles in a large amount can minimize particle sedimentation due to a viscosity increasing effect of the layer structural clay mineral particles.

The content of the layer structural clay mineral particles is preferably from 0.1 to 30% by weight, and more preferably from 1 to 10% by weight based on the total weight of the hydrophilic layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix phase in the invention. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybridpolymer by the sol-gel method.

Examples of the hydrophilic organic resin include polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, polyvinyl pyrrolidone, and saccharides.

A cationic resin may also be contained in the hydrophilic layer. Examples of the cationic resin include a polyalkylene-polyamine such as a polyethyleneamine or polypropylenepolyamine or its derivative, an acryl resin having a tertiary amino group or a quaternary ammonium group and diacrylamine. The cationic resin may be added in a form of fine particles. Examples of such particles include the cationic microgel described in Japanese Patent O.P.I. Publication No. 6-161101.

As the saccharides, oligosaccharides can be used, but polysaccharides are preferably used.

Examples of the polysaccharides include starches, celluloses, polyuronic acid and pullulan. Among these, cellulose derivatives such as a methyl cellulose salt, a carboxymethyl cellulose salt and a hydroxyethyl cellulose salt are preferred, and a sodium or ammonium salt of carboxymethyl cellulose is more preferred. These polysaccharides can form a preferred surface shape of the hydrophilic layer.

The hydrophilic layer may contain a light-to-heat conversion material such as an infrared absorbing dye.

Examples of the infrared absorbing dye include an organic compound such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound.

The surface of the hydrophilic layer preferably has a convexoconcave structure having a pitch of from 0.1 to 50 μm such as the grained aluminum surface of an aluminum PS plate. The water retention ability and the image maintaining ability are raised by such a convexoconcave structure of the surface. Such a convexoconcave structure can also be formed by adding in an appropriate amount a filler having a suitable particle size to the coating liquid of the hydrophilic layer. However, the convexoconcave structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance.

The shape of the convexoconcave structure such as the pitch and the surface roughness thereof can be suitably controlled by the kinds and the adding amount of the alkaline colloidal silica particles, the kinds and the adding amount of the water-soluble polysaccharide, the kinds and the adding amount of another additive, a solid concentration of the coating liquid, a wet layer thickness or a drying condition.

The pitch in the convexoconcave structure is preferably from 0.2 to 30 μm, and more preferably from 0.5 to 20 μm. A multi-layered convexoconcave structure may be formed in which a convexoconcave structure with a smaller pitch is formed on one with a larger pitch. The hydrophilic layer has a surface roughness Ra of preferably from 100 to 1000 nm, and more preferably from 150 to 600 nm.

The thickness of the hydrophilic layer is from 0.01 to 50 μm, preferably from 0.2 to 10 μm, and more preferably from 0.5 to 3 μm.

When there are plural hydrophilic layers in the invention, at least one of the hydrophilic layers contains particles A and B, and preferably, all the hydrophilic layers contain particles A and B.

(Hydrophilic Layer Coating Solution)

The hydrophilic layer in the invention can be obtained by coating a hydrophilic layer coating solution on a support and drying it. The hydrophilic layer comprises the above-described materials constituting the hydrophilic layer and a coating solvent. Examples of the coating solvent include water, alcohols and polyhydric alcohols.

A water-soluble surfactant may be added for improving the coating ability of the hydrophilic layer coating solution. A silicon atom-containing surfactant and a fluorine atom-containing surfactant are preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating solution).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions. The content of the phosphate is preferably from 0.1 to 5% by weight, and more preferably from 0.5 to 2% by weight in terms of amount excluding hydrated water.

(Coating) As a coater used for a hydrophilic layer coating solution on a substrate, there are coaters used in various coating methods such as a wire bar type coater, a curtain coater, and a slide coater, and in the invention, the slide coater and wire bar type coater are especially preferred.

When plural hydrophilic layers are coated, a slide coater for multi-layer coating is especially preferred also, and efficiently used in the invention.

As the slide coaters can be used those disclosed in Japanese Patent O.P.I. Publication Nos. 2002-153808, 2002-15380, 2002-162110, 2002-166219, 2002-192045, 2002-182333, 2 002-233804, 2002-248397, 2002-293262, 2002-254006, 2002-273229, 2002-3611462, 2003-024853, 2003-062517, 2003-112111, 2003-114500, and 2003-117463, and patent documents or literatures described therein.

As the slide coater for multi-layer coating, there are known slide coaters used in multilayer coating according to a slide bead coating or slide curtain coating method.

The hydrophilic layer is formed by coating a hydrophilic layer coating solution on a support and drying. The hydrophilic layer coating solution before coating is preferably subjected to dispersion treatment employing a medialess disperser. Among the medialess dispersers, an interior shearing medialess disperser is preferably used.

The interior shearing medialess disperser is a disperser comprising a rotor capable of rotating at high speed and a stator, in which dispersion is carried out by applying shearing force to the hydrophilic layer coating solution in a narrow clearance between the rotor and stator.

Examples of the disperser include CLEAR MIX produced by M TECHNIQUE, TORNADO produced by ASADA TEKKO Co., Ltd., and a high pressure homogenizer and particle sizer produced by NIRO SOAVI Co., Ltd.

Time from dispersion treatment to coating, which follows, is preferably from 0 to 3 minutes, in view of on-press developability.

The dispersion treatment is preferably carried out in a disperser installed in a coating solution supply pipe or a coating solution circulation pipe of a coating line. Plural dispersers provided in series enables more efficient dispersion.

As a method for installing a disperser in a coater, the structure of an extrusion coater disclosed in Japanese Patent O.P.I. Publication No. 5-50001, in which a stirring rotor is installed in the coater chamber, can be applied to a slide coater.

Dispersion of the coating solution can be carried out while circulating and supplying the coating solution. Circulating and supply of the coating solution is carried out, for example, by supplying a coating solution in an amount more than needed to a die chamber of a slide coater, taking out an excessive coating solution from the die chamber, and then returning the solution to a coating solution tank or a supply pipe from the coater to the coating solution tank.

(Drying)

The hydrophilic layer coating solution is coated on a substrate and then dried to form a hydrophilic layer.

Drying temperature is preferably not less than 70° C. When the substrate is comprised of resin, drying temperature is more preferably from 80 to 150° C., and when the substrate is comprised of metal, drying temperature is more preferably from 80 to 300° C.

Drying time is preferably from 1 second to 5 minutes, and more preferably from 5 seconds to 3 minutes. Since the substrate may be thermally damaged by a combination of drying temperature and drying time, a combination of drying temperature and drying time such that the substrate be not damaged should be selected.

As described above, it is preferred that the hydrophilic layer in the invention is formed by coating a hydrophilic layer coating solution on a substrate and drying it.

In the invention, the hydrophilic layer is preferably formed as follows. In a method for manufacturing a printing plate material comprising a substrate and provided thereon, a hydrophilic layer and an image formation layer, the hydrophilic layer is formed by coating, on a substrate, a hydrophilic layer coating solution containing particles (A) having a particle diameter of from 1 to 10 μm and having a new Mohs hardness of from 11 to 15, and particles (B) having a particle diameter of from 10 nm to less than 1 μm and having a true specific gravity greater than the particles (A).

(Image Formation Layer)

The image formation layer in the invention is an image formation layer capable of forming an image by imagewise exposure, and preferably a thermosensitive image formation layer capable of forming an image by heat generating on imagewise exposure of hydrophilic layer.

The thermosensitive image formation layer is preferably a so-called negative working image formation layer, which changes at exposed portions to a layer difficult to remove after imagewise exposure.

The image formation layer is preferably an image formation layer capable of being developed (on-press developed) on a plate cylinder of a printing press

As the image formation layer which changes at exposed portions to a layer difficult to remove from the hydrophilic layer after imagewise exposure, there is, for example, an image formation layer containing a water-soluble material or water-dispersible material and a hydrophobe precursor capable of changing a layer with hydrophilicity before exposure to a layer with hydrophobicity by heat.

As the hydrophobe precursor used in the image formation layer in the invention, there is, for example, a polymer whose property is capable of changing from a hydrophilic property (a water dissolving property or a water swelling property) or to a hydrophobic property by heating. Examples of the hydrophobe precursor include a polymer having an aryldiazosulfonate unit as disclosed in for example, Japanese Patent O.P.I. Publication No. 200-56449. In the image formation layer in the invention, microcapsules encapsulating a hydrophobic material, blocked isocyanate compounds or thermoplastic hydrophobic particles such as heat melting particles or heat fusible particles are preferably used as the hydrophobe precursor.

As the thermoplastic hydrophobic particles, there are heat melting particles or heat fusible particles, as described later.

The heat melting particles used in the invention are particularly particles having a low melt viscosity, which are particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 300° C. lowers ink receptive sensitivity.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to stain which may be caused by scratch is further enhanced.

The heat melting particles are preferably dispersible in water. The average particle size thereof is preferably from 0.01 to 10 μm, and more preferably from 0.1 to 3 μm. When a layer containing the heat melting particles is coated on the porous hydrophilic layer, the particles having an average particle size less than 0.01 μm may enter the pores of the hydrophilic layer or the valleys between the neighboring two peaks on the hydrophilic layer surface, resulting in insufficient development-on-press and in stain occurrence at the background. The particles having an average particle size exceeding 10 μm may result in lowering of dissolving power.

The composition of the heat melting particles may be continuously varied from the interior to the surface of the particles. The particles may be covered with a different material. Known microcapsule production method or sol-gel method can be applied for covering the particles. The heat melting particle content of the image formation layer is preferably 1 to 90% by weight, and more preferably 5 to 80% by weight based on the total layer weight.

The heat fusible particles in the invention include thermoplastic hydrophobic polymer particles. Although there is no specific limitation to the upper limit of the softening point of the thermoplastic hydrophobic polymer, the softening point is preferably lower than the decomposition temperature of the polymer. The weight average molecular weight (Mw) of the thermoplastic hydrophobic polymer is preferably within the range of from 10,000 to 1,000,000.

Examples of the polymer consisting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The heat fusible particles are preferably dispersible in water. The average particle size of the heat fusible particles is preferably from 0.01 to 10 μm, and more preferably from 0.1 to 3 μm.

The composition of the heat fusible particles may be continuously varied from the interior to the surface of the particles. The particles may be covered with a different material. Known microcapsule production method or sol-gel method can be applied for covering the particles. The heat fusible particle content of the layer is preferably 1 to 90% by weight, and more preferably 5 to 80% by weight based on the total layer weight.

Microcapsules used include those encapsulating hydrophobic materials disclosed in Japanese Patent O.P.I. Publication Nos. 2002-2135 and 2002-19317. The average microcapsule size of the microcapsules is preferably from 0.1 to 10 μm, more preferably from 0.3 to 5 μm, and still more preferably from 0.5 to 3 μm.

[Blocked Isocyanate Compound]

The blocked isocyanate compound is a compound obtained by addition reaction of an isocyanate compound with a blocking agent described below. The blocked isocyanate compound used in the image formation layer is preferably in the form of aqueous dispersion of a compound described below. Coating of the aqueous dispersion provides good on press developability.

(Isocyanate Compound)

Examples of the isocyanate compound include an aromatic polyisocyanate such as diphenylmethane diisocyanate (MDI), tolylene diisocyanate (TDI), polyphenylpolymethylene polyisocyanate (crude MDI), or naphthalene diisocyanate (NDI); an aliphatic polyisocyanate such as 1,6-hexamethylene diisocyanate (HDI), or lysine diisocyanate (LDI); an alicyclic polyisocyanate such as isophorone diisocyanate (IPDI), dicyclohexylmethane diisocyanate (hydrogenation MDI), or cyclohexylene diisocyanate; an aromatic aliphatic Polyisocyanate such as xylylene diisocyanate (XDI), or tetramethylxylene diisocyanate (TMXDI); and their modified compounds such as those having a burette group, an isocyanurate group, a carbodiimide group, or an oxazolidine group); and a urethane polymer having an isocyanate group in the molecular end, which is comprised of an active hydrogen-containing compound with a molecular weight of from 50 to 5,000 and the polyisocyanate described above. The polyisocyanates described in Japanese Patent O.P.I. Publication No. 10-72520 are preferably used.

Among those polyisocyanates, tolylene diisocyanate is especially preferred in view of high reactivity.

(Blocking Material)

Examples of the blocking material include an alcohol type blocking material such as methanol, or ethanol; a phenol type blocking material such as phenol or cresol; an oxime type blocking material such as formaldoxime, acetaldoxime, methyl ethyl ketoxime, methyl isobutyl ketoxime, cyclohexanone oxime, acetoxime, diacetyl monoxime, or benzophenone oxime; an acid amide type blocking material such as acetanilide, ε-caprolactam, or γ-butyrolactam; an active methylene containing blocking material such as dimethyl malonate or methyl acetoacetate; a mercaptan type blocking material such as butyl mercaptan; an imide type blocking material such as succinic imide or maleic imide; an imidazole type blocking material such as imidazole or 2-methylimidazole; a urea type blocking material such as urea or thiourea; an amine type blocking material such as diphenylamine or aniline; and an imine type blocking material such as ethylene imine or polyethylene imine. Among these, the oxime type blocking material is preferred.

It is preferred that the content of the blocking material is such an amount that the amount of the active hydrogen of the blocking material is from 1.0 to 1.1 equivalent of the isocyanate group of the isocyanate compound. It is preferred that when an active hydrogen-containing additive such as a polyol described later is used in combination, the content of the blocking material is such an amount that the total amount of the active hydrogen of the blocking material and the additive is from 1.0 to 1.1 equivalent of the isocyanate group of the isocyanate compound. The amount less than 1.0 equivalent of the active hydrogen produces an unreacted isocyanate group, while the amount exceeding 1.1 equivalent of the active hydrogen results in excess of blocking material, which is undesirable.

The releasing temperature of blocking material from the blocked isocyanate compound is preferably from 80 to 200° C., more preferably from 80 to 160° C., and still more preferably from 80 to 130° C.

[Polyol]

The blocked isocyanate compound in the invention is preferably an adduct of an isocyanate with a polyol.

The adduct derived from the polyol can improve storage stability of the blocked isocyanate compound. When the image formation layer containing the adduct is imagewise heated, the resulting image increases image strength, resulting in improvement of printing durability.

Examples of the polyol include a polyhydric alcohol such as propylene glycol, triethylene glycol, glycerin, trimethylol methane, trimethylol propane, pentaerythritol, neopentyl glycol, 1,6-hexylene glycol, hexamethylene glycol, xylylene glycol, sorbitol or sucrose; polyether polyol which is prepared by polymerizing the polyhydric alcohol or a polyamine with ethylene oxide and/or propylene oxide; polytetramethylene ether polyol; polycarbonate polyol; polycaprolactone polyol; polyester polyol, which is obtained by reacting the above polyhydric alcohol with polybasic acid such as adipic acid, phthalic acid, isophthalic acid, terephthalic acid, sebatic acid, fumaric acid, maleic acid, or azelaic acid; polybutadiene polyol; acrylpolyol; castor oil; a graft copolymer polyol prepared by graft polymerization of a vinyl monomer in the presence of polyether polyol or polyester polyol; and an epoxy modified polyol. Among these, a polyol having a molecular weight of from 50 to 5,000 such as propylene glycol, triethylene glycol, glycerin, trimethylol methane, trimethylol propane, pentaerythritol, neopentyl glycol, 1,6-hexylene glycol, butane diol, hexamethylene glycol, xylylene glycol, or sorbitol is preferred, and a low molecular weight polyol having a molecular weight of from 50 to 500 is especially preferred.

It is preferred that the content of the polyol is such an amount that the amount of the hydroxyl group of the polyol is from 0.1 to 0.9 equivalent of the isocyanate group of the isocyanate compound. The above range of the hydroxyl group of the polyol provides improved storage stability of the blocked isocyanate compound.

[Blocking Method]

As a blocking method of an isocyanate compound, there is, for example, a method comprising the steps of dropwise adding a blocking material to the isocyanate compound at 40 to 120° C. while stirring under an anhydrous condition and an inert gas atmosphere, and after addition, stirring the mixture solution for additional several hours. In this method, a solvent can be used, and a known catalyst such as an organometallic compound, a tertiary amine or a metal salt can be also used. Examples of the organometallic compound include a tin catalyst such as stannous octoate, dibutyltin diacetate, or dibutyltin dilaurate; and a lead catalyst such as lead 2-ethylhexanoate. Examples of the tertiary amine include triethylamine, N,N-dimethylcyclohexylamine, triethylenediamine, N,N′-dimethylpiperazine, and diazabicyclo (2,2,2)-octane. Examples of the metal salt include cobalt naphthenate, calcium naphthenate, and lithium naphthenate. These catalysts are used in an amount of ordinarily from 0.001 to 2% by weight, and preferably from 0.01 to 1% by weight based on 100 parts by weight of isocyanate compound.

The blocked isocyanate compound in the invention, which is a reaction product of an isocyanate compound, a polyol, and a blocking material, is obtained by reacting the isocyanate compound with the polyol, and then reacting a residual isocyanate group with the blocking material or by reacting the isocyanate compound with the blocking material, and then reacting a residual isocyanate group with the polyol. The blocked isocyanate compound in the invention has an average molecular weight of preferably from 500 to 2,000, and mote preferably from 600 to 1,000. This range of the molecular weight provides good reactivity and storage stability.

[Manufacture of Aqueous Dispersion]

The blocked isocyanate compound obtained above is added to an aqueous solution containing a surfactant, and vigorously stirred in a homogenizer to obtain an aqueous dispersion of blocked isocyanate compound. Examples of the surfactant include an anionic surfactant such as sodium dodecylbenzene sulfonate, sodium lauryl sulfate, sodium dodecyldiphenylether disulfonate, or sodium dialkyl succinate sulfonate; a nonionic surfactant such as polyoxyethylenealkyl ester or polyoxyethylenealkyl aryl ester; and an amphoteric surfactant including an alkyl betaine such as lauryl bataines or stearyl betaine and an amino acid such as lauryl β-alanine, lauryldi(aminoethyl)glycine, or octyldi(aminoethyl)glycine. These surfactant may be used singly or in combination. Among these, the nonionic surfactant is preferred.

The solid content of the aqueous dispersion of the blocked isocyanate compound is preferably from 10 to 80% by weight. The surfactant content of the aqueous dispersion is preferably from 0.01 to 20% by weight based on the solid content of the aqueous dispersion.

When an organic solvent is used in a blocking reaction of the isocyanate compound, the organic solvent can be removed from the resulting aqueous dispersion.

The hydrophobe precursor content of the image formation layer is preferably 1 to 90% by weight, and more preferably 5 to 80% by weight based on the total layer weight.

The image formation layer in the invention may contain a water-soluble material. Examples of the water-soluble material include the following compounds.

[Water-Soluble Polymer]

Examples of the water-soluble material include a known water-soluble polymer, which is soluble in an aqueous solution having a pH of from 4 to 10.

Typical examples of the water-soluble polymer include polysaccharides, polyethylene oxide, polypropylene oxide, polyvinyl alcohol, polyethylene glycol (PEG), polyvinyl ether, polyacrylic acid, polyacrylic acid salt, polyacrylamide, and polyvinyl pyrrolidone. Among these, polysaccharides, polyacrylic acid, polyacrylic acid salt, polyacrylamide, and polyvinyl pyrrolidone are preferred.

Examples of the polysaccharides include starches, celluloses, polyuronic acid and pullulan. Among these, cellulose derivatives such as a methyl cellulose salt, a carboxymethyl cellulose salt and a hydroxyethyl cellulose salt are preferred, and a sodium or ammonium salt of carboxymethyl cellulose is more preferred.

The polyacrylic acid, polyacrylic acid salt, and polyacrylamide have a molecular weight of preferably from 3,000 to 1,000,000, and more preferably from 5,000 to 500,000.

Of these, polyacrylic acid salt such as sodium polyacrylate is most preferred. The polyacrylic acid salt efficiently works as a hydrophilization agent of the hydrophilic layer, and enhance hydrophilicity of a hydrophilic layer surface which is revealed on on-press development.

[Oligosaccharides]

As the water-soluble material, oligosaccharides can be used other than the water-soluble polymers described above.

Examples of the oligosaccharides include raffinose, trehalose, maltose, galactose, sucrose, and lactose, and trehalose is especially preferred.

[Another Material Optionally Contained in the Image Formation Layer]

The image formation layer can contain infrared absorbing agent as a light-to-heat conversion material.

It is necessary that the content of the infrared absorbing dye in the image formation layer be adjusted considering color density of the layer or contamination of a printing press on on-press development. However, the content of the infrared absorbing dye in the image formation layer is preferably from 0.001 g/m² to less than 0.2 g/m², and more preferably from 0.001 g/m² to less than 0.05 g/m².

A dye having a low absorption to visible light is preferably used.

The image formation layer in the invention can contain a surfactant. A silicon-contained surfactant, a fluorine-contained surfactant or an acetylene glycol surfactant can be used, and a silicon-contained surfactant or an acetylene glycol surfactant is preferred in minimizing stain occurrence. The surfactant content of the image formation layer (the solid component of the coating liquid) is preferably from 0.01 to 3% by weight, and more preferably from 0.03 to 1% by weight.

The image formation layer in the invention can contain an acid (phosphoric acid or acetic acid) or an alkali (sodium hydroxide, silicate, or phosphate) to adjust pH.

For the particles (A) and (B) used in the hydrophilic layer, and components used in the image formation layer, the materials as described above are preferably used in the invention.

(Substrate)

As a substrate for the support in the invention, those well known used as substrates for printing plates can be used.

Examples of the substrate include a metal plate, a plastic film sheet, a paper sheet treated with polyolefin, and composite sheets such as laminates thereof. The thickness of the substrate is not specifically limited as long as a printing plate having the substrate can be mounted on a printing press, and is advantageously from 50 to 500 μm in easily handling.

In the invention, the plastic film sheet is especially preferred as the substrate.

Examples of the plastic film include a polyethylene terephthalate film, a polyethylene naphthalate film, a polyimide film, a polyamide film, a polycarbonate film, a polysulfone film, a polyphenylene oxide film, and a cellulose ester film. The plastic film is preferably a polyethylene terephthalate film or a polyethylene naphthalate film. In order to increase adhesion between the support and a coating layer, it is preferred that the surface of the plastic film is subjected to adhesion increasing treatment or is coated with a subbing layer. Examples of the adhesion increasing treatment include corona discharge treatment, flame treatment, plasma treatment and UV light irradiation treatment. Examples of the subbing layer include a layer containing gelatin or latex. The subbing layer can contain a known organic or inorganic electrically conductive material.

A substrate with a known backing layer coated can be used in order to control slippage of a rear surface of the substrate on the backing layer side, for example, in order to reduce friction between the rear surface and a plate cylinder of a printing press.

### EXAMPLES

The present invention will be explained below employing the following examples. In the examples, “parts” is parts by weight, unless otherwise specifically specified.

(Preparation of Substrate)

A 0.24 mm thick aluminum plate web (material 1050, refining H16) was immersed in an aqueous 1% by weight sodium hydroxide solution at 50° C., while transporting, so that an aluminum dissolution amount was 2 g/m², washed with water, immersed in an aqueous 0.1% by weight hydrochloric acid solution at 25° C. for 5 seconds to neutralize, washed with water, and then dried in a 120° C. dry zone for 45 seconds.

Subsequently, the following subbing layer coating solution was coated on the resulting web, dried in a 150° C. dry zone for 45 seconds to prepare a subbed aluminum support with a subbing layer dry thickness of 2.0 g/m².

The subbing layer coating was carried out employing a slide bead coater described later.

The subbing layer coating solution was prepared as follows:

Materials as shown in Table 1, except for the surfactant, were sufficiently dispersed and mixed employing a homogenizer, and the resulting mixture was added with the surfactant, vigorously stirred, and filtered to obtain a subbing layer coating solution.

Composition of Subbing Layer Coating Solution (with a Solid Content of 20% by Weight)

TABLE 1

| | Parts by |
|---|---|
| Materials | weight |
| Colloidal silica (alkali type): Snowtex XS | 63.00 |
| (solid 20% by weight, produced by Nissan | |
| Kagaku Co., Ltd.) | |
| Acryl emulsion AE986A (solid content of 35.5% | 14.08 |
| by weight, Tg of 2° C., produced by JSR Co., | |
| Ltd.) | |
| Aqueous dispersion (solid content of 30% by | 4.53 |
| weight) of carbon black pigment particle | |
| SD9020 (with a true specific gravity of 2.0 g/cm³, | |
| and with an average particle size of | |
| not more than 100 nm, produced by Dainippon | |
| Ink Co., Ltd.) | |
| Porous metal oxide particles Silton JC 20 | 1.00 |
| (porous aluminosilicate particles having an | |
| average particle size of 2 μm, produced by | |
| Mizusawa Kagaku Co., Ltd.) | |
| Aqueous 1% by weight solution of silicon- | 4.00 |
| containing surfactant (Produced by Nippon | |
| Unicar Co., Ltd.) | |
| Pure water | 13.39 |

(Preparation of Hydrophilic Layer Coating Solution)

Hydrophilic layer coating solutions were prepared as follows:

Materials as shown in Table 2, except for the surfactant, were sufficiently dispersed and mixed, employing a homogenizer, and the resulting mixture was added with the surfactant, vigorously stirred, and filtered to obtain hydrophilic layer coating solutions a through f.

Composition of Hydrophilic Layer Coating Solutions (with a Solid Content of 30.0% by Weight)

TABLE 2

Hydrophilic layer coating solution

| Materials | a | b | c | d | e | f |
|---|---|---|---|---|---|---|
| i | 44.50 | 54.50 | 49.50 | 66.50 | 59.50 | 59.50 |
| ii | | 22.50 | | | | |
| iii | 12.00 | | 12.90 | | | |
| iv | | | | 25.00 | 25.00 | 25.00 |
| v | 1.20 | 1.20 | 1.20 | 1.20 | 1.20 | 1.20 |
| vi | | | 2.10 | | | |
| vii | | | | 2.40 | | |
| viii | 4.50 | | | | 4.50 | |
| ix | | 4.50 | | | | 4.50 |
| x | 3.00 | 3.00 | 3.00 | 3.00 | 3.00 | 3.00 |
| Pure water | 34.80 | 14.30 | 31.30 | 1.90 | 6.80 | 6.80 |

i: Colloidal silica (alkali type): Snowtex S (solid 30% by weight and an average particle size of 8 nm, produced by Nissan Kagaku Co., Ltd.)
ii: Aqueous 40% by weight dispersion of Cu—Fe—Mn type metal oxide black pigment: TM-3550 black powder {having a true specific gravity of 5.8 g/m³ and an average particle size of 0.1 μm, produced by Dainichi Seika Kogyo Co., Ltd. (including 0.2% by weight of dispersant)}
iii: Black iron oxide pigment particles ABL-207 (octahedral form, having a true specific gravity of about 5.0 g/m³, an average particle size of 0.2 μm, a specific surface area of 6.7 m²/g, Hc of 9.95 kA/m, σs of 85.7 Am²/kg, and σr/σs of 0.112, produced by Titan Kogyo K.K.)
iv: Aqueous dispersion (solid content of 30% by weight) of carbon black pigment particles SD9020 (having a true specific gravity of 2.0 g/cm³, and an average particle size of not more than 100 nm, produced by Dainippon Ink Co., Ltd.)
v: Aqueous 10% by weight sodium phosphate.dodecahydrate solution (Reagent produced by Kanto Kagaku Co., Ltd.)
vi: Porous metal oxide particles Silton JC 50 (white porous aluminosilicate particles having an average particle size of 5 μm, a true specific gravity of about 2.2 g/cm³, and a new Mohs hardness of not more than 5, produced by Mizusawa Kagaku Co., Ltd.)
vii: Fused silica FB-6D (white) (having an average particle size of 6 μm, a true specific gravity of about 2.21 g/cm³, and a new Mohs hardness of 7, produced by Denki Kagaku Kogyo Co., Ltd.)
viii: α-Alumina particles SUMICORUNDUM AA5 (having an average particle size of 5 μm, a true specific gravity of 4.4 g/cm³, and a new Mohs hardness of 12, produced by Sumitomo Kagaku Co., Ltd.)
ix: α-Alumina particles SUMICORUNDUM AA2 (having an average particle size of 2 μm, a true specific gravity of 4.4 g/cm³, and a new Mohs hardness of 12, produced by Sumitomo Kagaku Co., Ltd.)
x: Aqueous 1% by weight solution of silicon-containing surfactant (produced by Nippon Unicar Co., Ltd.)

### Example 1

### Sedimentation of Particles in Hydrophilic Layer Coating Solution

Twenty grams of each of hydrophilic layer coating solutions a through f were placed in a glass vessel and allowed to stand. After that, sedimentation of the white particles in each hydrophilic layer coating solution was observed and evaluated according to the following criteria.

The results are shown in Table 4.
A: No white particle sedimentation was observed in the hydrophilic layer coating solution after a 4 hours' standstill.
B: White particle sedimentation was observed in the hydrophilic layer coating solution after a 2 hours' standstill.
C: White particle sedimentation was observed in the hydrophilic layer coating solution after a 1 hour's standstill.
D: White particle sedimentation was observed in the hydrophilic layer coating solution after a 30 minutes' standstill.
E: White particle sedimentation was observed in the hydrophilic layer coating solution within 15 minutes after standstill.

### Example 2

### Sedimentation in Coater Die Chamber of Particles in Hydrophilic Layer Coating Solution

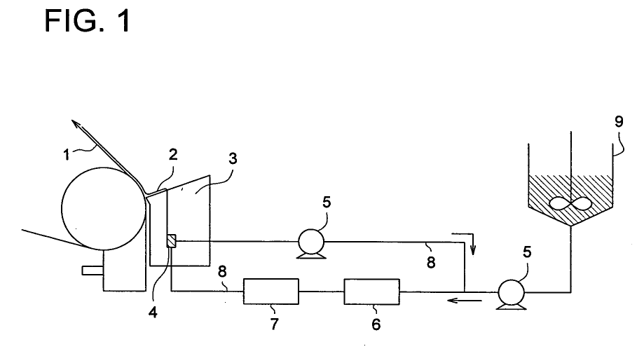

Employing a coating line employing a slide bead coater as shown in FIG. 1, each hydrophilic layer coating solution was coated on the subbing layer of the subbed aluminum support to form a hydrophilic layer.

In FIG. 1, numerical number 1 represents a substrate, numerical number 2 a hydrophilic layer coating solution, numerical number 3 a slide coater, numerical number 4 a coater die chamber, numerical number 5 a circulation pump, numerical number 6 a disperser, numerical number 7 a filter, numerical number 8 a coating solution supply pipe, and numerical number 9 a coating solution tank.

The coating solution was circulated as shown in FIG. 1, and an ultrasonic disperser was used as a disperser 6. The solution supply speed was 10 m/min, and drying was carried out at 150° C. for 90 seconds employing a dryer (not illustrated in FIG. 1). A dry coating amount of the hydrophilic layer is shown in Table 1.

After 500 m of the hydrophilic layer was formed, the slide coater 3 was decomposed. After that, white particle sedimentation in the coating solution in the coater die chamber 4 was observed and evaluated according to the following criteria.

The results are shown in Table 4.
A: No white particle sedimentation was observed.
B: Slight white particle sedimentation was observed.
C: Apparent white particle sedimentation was observed.
D: White particles were piled.

### Example 3

### Evaluation of Scratch Resistance of Printing Plate Material Sample

The image formation layer coating solution as shown in Table 3 below was coated on the hydrophilic layer of the aluminum support obtained in Example 2 above to form an image formation layer.

The image formation layer coating solution was coated through a wire bar, in which transporting speed was 20 m/min, and drying was carried out at 70° C. for 45 seconds, employing a dryer. A dry coating amount of the image formation layer was 0.3 g/m². The resulting image formation layer was further subjected to aging at 55° C. for 48 hours. Thus, printing plate material samples 1 through 6 were prepared. Composition of image formation layer coating solution (with a solid content of 6.0% by weight)

TABLE 3

| Materials | Parts by weight |
|---|---|
| Blocked isocyanate compound aqueous | 8.18 |
| dispersion WB-700 with a solid content of | |
| 44% by weight, produced by Mitsui Takeda | |
| Chemical Co., Ltd. (isocyanate compound: | |
| trimethylol propane adduct of TDI, blocking | |
| agent: oxime type, dissociation | |
| temperature: 120° C.) | |
| Stearic acid amide emulsion L-271 with a | 9.60 |
| solid content of 25% by weight, produced by | |
| Chukyo Yushi Co., Ltd.) | |
| Pure water | 82.22 |

Of each 500 m printing plate material sample, portions at the hydrophilic layer coating beginning edge and the hydrophilic layer coating end were sampled for evaluation.

The printing plate material sample was exposed to infrared laser as follows.

[Exposure]

The printing plate material sample was wounded around an exposure drum with the image formation layer facing outwardly, and exposed to laser beams (with a 830 nm wavelength and with a spot diameter of 18 μm) at an exposure energy of 300 mJ/cm² to form an image with a resolution of 2400 dpi (“dpi” means a dot number per 2.54 cm) and with a screen line number of 175. The image comprised a solid image and a dot image with a dot area of from 1 to 99%.

The unexposed portions (non-image portions of printing plate) of the exposed sample were subjected to scratching test as follows.

[Scratching Test]

The printing plate material sample surface (image formation layer surface) was subjected to scratching test employing a HEIDON tester. As a touching needle, a 0.8 mmφ sapphire needle was used. Loads with a weight of from 50 to 300 g were applied to the sapphire needle, changing the weight at an interval of 50 g.

The resulting printing plate material sample was evaluated for printability as follows.

[Printing Method]

The resulting printing plate sample being mounted on a plate cylinder of a printing press, DAIYA 1F-1 produced by Mitsubishi Jukogyo Co., Ltd., printing was carried out in the same printing condition and printing sequence as a conventional PS plate, employing coated paper, a dampening solution, a 2% by weight solution of Astromark 3 (produced by Nikken Kagaku Kenkyusyo Co., Ltd.) and printing ink (Toyo King Hyunity M Magenta, produced by Toyo Ink Manufacturing Co. Ltd.).

(Evaluation of Printability)

[Initial Printability]

Printing started, and the first one hundred printed matters were observed for evaluated of initial printability. The number of printing matters printed until a printing matter was obtained which had a solid image with a density of not less than 1.5 without stain at non-image portions, and filled-up at a 90% dot image, was evaluated as initial printability, which was one evaluation of printability. The results are shown in Table 4.

[Stain Elimination Property]

After printing was carried out to obtain 200 printed matters, printing stopped, and then re-started without supplying dampening water, and was continued until a solid image was formed at the entire surface of printing plate. Subsequently, printing was further continued supplying dampening water to the printing plate surface to obtain 50 printed matters. Stain at non-image portions of the fiftieth printing matter was visually observed, and evaluated as stain elimination property, which was one evaluation of printability, according to the following criteria. The results are shown in Table 4.
A: No stain was observed.
B: Slight stain was observed.
C: Apparent stain was observed.
   (Evaluation of Scratch Resistance)
   [Stain at Scratched Portions]

Printing started to obtain 100 printed matters, and satin of the one hundredth printed matter was observed at the scratched portions.

The maximum load weight at which stain due to the scratches was not observed at the scratched portions was determined, and was evaluated as scratch resistance. The results are shown in Table 4.

As is apparent from Table 4, the inventive printing plate material samples can be manufactured with an excellent production stability without no particle sedimentation on coating, and provide an excellent printability and a high scratch resistance.

TABLE 4

| | | | Hydrophilic | | | | | | | | |
|---|---|---|---|---|---|---|---|---|---|---|---|
| | Hydrophilic layer | | layer coating | | | | | | | | |
| | | Dry | solution | | Initial | | Stain | | Scratch | | |
| | Kinds of | coating | particle | | printability | | elimination | | resistance | | |
| Sample | coating | amount | sedimentation | | (Number) | | property | | (g) | | |
| No. | solution | (g/m²) | *i | *ii | *1 | *2 | *1 | *2 | *1 | *2 | Remarks |
| 1 | a | 7.0 | A | B | 15 | 15 | A | A | 300 | 300 | Inv. |
| 2 | b | 3.0 | B | B | 15 | 15 | A | A | 300 | 300 | Inv. |
| 3 | c | 7.0 | A | B | 15 | 15 | A | A | 150 | 150 | Comp. |
| 4 | d | 5.0 | D | C | 30 | 30 | B | B | 150 | 100 | Comp. |
| 5 | e | 5.0 | E | D | 30 | 30 | B | C | 200 | 100 | Comp. |
| 6 | f | 2.5 | E | D | 30 | 30 | B | C | 200 | 100 | Comp. |

*i: Particle sedimentation in hydrophilic layer coating solution after standing
*ii: Particle sedimentation in hydrophilic layer coating solution in coater die chamber
*1: At the coating beginning edge portions of hydrophilic layer
*2: At the coating end portions of hydrophilic layer

What is claimed is:

1. A printing plate material comprising a substrate and provided thereon, a hydrophilic layer and an image formation layer, wherein the hydrophilic layer contains particles (A) having a particle size of from 1 to 10 μm and having a new Mohs hardness of from 11 to 15, and particles (B) having a particle size of from 10 nm to less than 1 μm, the particles (B) having a true specific gravity greater than the particles (A).

2. The printing plate material of claim 1, wherein the particles (A) are metal oxide particles.

3. The printing plate material of claim 1, wherein the particles (B) have a light-to-heat conversion function.

4. The printing plate material of claim 1, wherein the content of the particles (B) is higher than that of the particles (A) in the hydrophilic layer.

5. The printing plate material of claim 1, wherein the image formation layer contains thermoplastic hydrophobic particles.

6. The printing plate material of claim 1, wherein the image formation layer contains microcapsules encapsulating a hydrophobic material.

7. The printing plate material of claim 1, wherein the image formation layer contains a blocked isocyanate compound.

8. The printing plate material of claim 1, wherein the total content of the particles (A) and (B) in the hydrophilic layer is from 15 to 70% by weight.

9. The printing plate material of claim 1, wherein the total content of the particles (A) and (B) in the hydrophilic layer is from 30 to 70% by weight.

10. The printing plate material of claim 1, wherein the hydrophilic layer and the image formation layer are provided on the substrate in that order.
